(19) United States
(12) Patent Application Publication
(10) Pub. No.: US 2018/0289040 A1
(43) Pub. Date: Oct. 11, 2018

(54) METHOD AND SYSTEM FOR PRODUCING AQUACULTURE

(71) Applicant: The United States of America,as represented by the Secretary of Agriculture, Washington, DC (US)

(72) Inventors: FREDERIC T. BARROWS, Bozeman, MT (US); JASON B. FROST, LIVINGSTON, MT (US); KESHUN LIU, POCATELLO, ID (US)

(21) Appl. No.: 16/003,891

(22) Filed: Jun. 8, 2018

Related U.S. Application Data
(62) Division of application No. 14/479,654, filed on Sep. 8, 2014.

(51) Int. Cl. A23K 40/20; B29C 47/88; A23K 50/80; B29C 47/30; B29C 47/86; A23K 40/25; B29C 47/92; B29C 47/08; B29C 47/00

(52) U.S. Cl. CPC A23K 40/20; B29C 2947/92971; A23K 50/80; B29C 47/30; B29C 47/864; A23K 40/25; B29C 47/92; B29C 47/0837; B29C 47/0066; B29C 47/0016; B29C 2947/92514; B29C 2947/926; B29C 2947/92704; B29C 2947/92723; B29C 47/8815

(57) ABSTRACT

The method and system produces a high-moisture aquatic feed that is stable in water and has a texture that more closely resembles naturally-occurring aquatic feedstocks. The system includes a “tempering unit” that is structured to allow an operator to control the temperature of a low-carbohydrate high-moisture extrudate after the extrudate leaves a conventional extruder. As the extrudate flows through a tubular matrix within the tempering unit, expansion of the extrudate is controlled to produce the high-moisture water-stable aquafeed.

### FIELD OF THE INVENTION

The disclosed method and system relates to the production of aquaculture feed (i.e. “aquafeed”). Specifically, the method and system described herein relates to producing aquafeed that contains over 45% moisture in a water-stable stable form.

### BACKGROUND OF THE INVENTION

Aquaculture is a form of agriculture that involves the propagation, cultivation, and marketing of aquatic animals and plants in a controlled environment. The aquaculture industry is currently the fastest growing food production sector in the world. World aquaculture produces approximately 60 million tons of seafood, which is worth more than U.S. $70 billion annually. Today, farmed fish account for approximately 50% of all fish consumed globally. This percentage is expected to increase as a result of static supplies from capture fisheries in both marine and freshwater environments and increasing seafood consumption (i.e., total and per capita). There are more than 2,500 different species of aquatic organisms that are cultured today and most are undomesticated.

Developed aquaculture industries use a feed pellet produced by an extrusion process. Approximately 95% of all aquatic feeds are produced with this technology. The most common prior art aquatic feed producing processes are characterized by a cooking extrusion process which produces an extrudate having a relatively low moisture content (15-35%). Due to sudden drop of pressure when exiting the extruder, the extrudate is typically expanded and has a porous texture. The porous extrudate is then dried and cut into pellets. Although the hard porous texture is desirable for preventing breakage during mechanical or pneumatic conveying or general shipping, undomesticated, sick or stressed domesticated aquatic organisms often refuse to eat a hard crunchy food particle.

To address the hard texture issue, aquaculture feed pellet manufacturers currently attempt to moisturize the feed pellets with water just prior to feeding. One prior art moisturization method comprises placing feed pellets in water and subjecting the pellets to a suction process to remove trapped air, and then pressurizing the pellets with additional moisture. Other prior art methods attempt to impart moisture to the dried pellets by introducing the pellets into a water-circulating loop and exposing the pellets therein to pressure changes that result in the impregnation of the pellets with water. However, all prior art methods are generally inefficient and only marginally effective. The prior art “moisturized” product is just a wet version of the original dried pellets. In the water, the “moisturized” pellets quickly disintegrate and do not resemble the natural foods preferred by most aquaculture stocks.

The prior art aquafeed process generally requires the addition of starch (typically 10-15%) into raw feed mix as a binding agent. As a result, the final feed product contains substantial amounts of starch, in addition to other carbohydrates (such as cell wall materials) naturally present in the feed ingredient. Increased carbohydrate in the feed products (due to addition of starch) can be detrimental to some fish species, and is generally undesirable.

The need exists for an aquatic feed that is not only durable but also stable in the water and resembles the natural foods preferred by the cultured aquatic stock. There is also a need for an aquafeed that is lower in total carbohydrate content—particularly in starch content.

The method described herein produces a different type of aquatic feed product that addresses the needs of the aquaculture industry. The aquafeed product made by the current method contains significantly reduced amounts of total carbohydrates (particularly starch) as compared to conventional feed, but generally over 45% moisture (before an optional post-production drying step). The aquafeed product produced by the current process has a texture similar to natural feeds such as sardines.

The method and apparatus described herein results in an improved texture that is appealing to fish accustomed to consuming natural feeds—and consequently leads to an increase in feed consumption. More importantly, the product described herein does not disintegrate upon soaking in water as quickly as traditional feeds do, but holds its texture and dry mass for more than 24 hrs. Consequently, the product has application to slow-feeding aquatic animals like shrimp, abalone, grazing species of fish (rudderfish or Kysoids), and sturgeon—in addition to traditional fish stocks. The increased water stability of the new product also contributes to the preservation of tank water quality.

### SUMMARY OF THE INVENTION

This disclosure is directed to a system for producing a water-stable aquafeed. The system comprises a tempering unit that is attached to an extruder. The tempering unit includes a tubular insert positioned within the tempering unit, and a fluid circulating assembly. The fluid circulating assembly comprises a tempering unit inlet port that allows an injection of a tempering fluid into the tempering unit. The circulating assembly is structured to allow the temperature of the tempering fluid to be controlled and to circulate around the tubular insert. The system is configured to cause an extrudate to flow through the tubular insert so that a temperature within the tubular insert is controlled to produce a water-stable aquafeed.

The disclosure is also directed to a method of producing water-stable aquafeed. In accordance with the method, a raw mix is prepared and deposited into extruder. A tempering unit is attached to the extruder. A tubular insert is positioned within the tempering unit so that the tubular insert receives an extrudate from the extruder. The tubular insert controls the expansion of the extrudate within the tempering unit. A tempering fluid is circulated around the tubular insert thereby controlling the temperature of the extrudate within the tubular insert so that a water-stable aquafeed is produced from the tubular insert within the tempering unit.

### BRIEF DESCRIPTION OF THE DRAWINGS

FIG. 1 is a flow chart showing the method and processing system described herein.

FIG. 2 is a perspective schematic view of the tempering unit.

FIG. 3 is a front schematic view of the tubular insert in a “bar” format.

FIG. 4 is a front schematic view of the tubular insert in a “cross” format.

FIG. 5 shows the results of a water stability test on the high-moisture water-stable aquafeed as well a conventional feed.

FIG. 6 shows the results of a post-submersion structural integrity test on high-moisture water-stable aquafeeds as well as conventional feed.

### DETAILED DESCRIPTION OF PREFERRED EMBODIMENTS

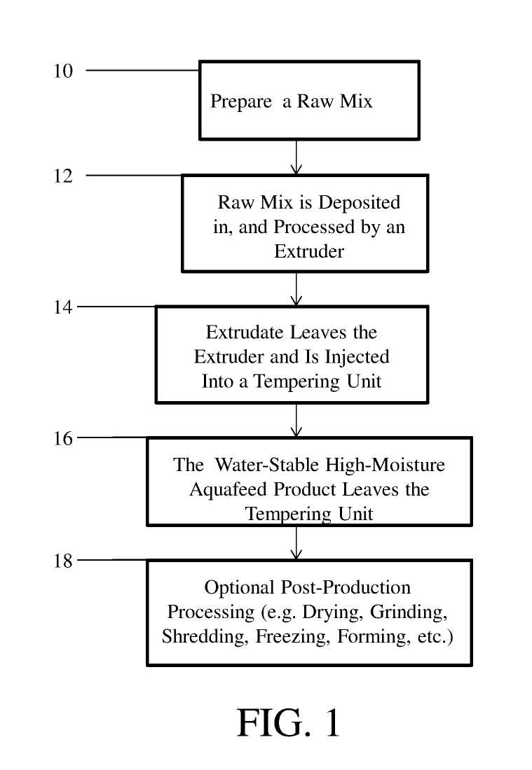

The present invention comprises a method and apparatus for producing a feed for aquatic organisms. FIG. 1 is a flow chart that generally shows the method and production system described herein. The final product of the current method and system is a water-stable high-moisture aquafeed.

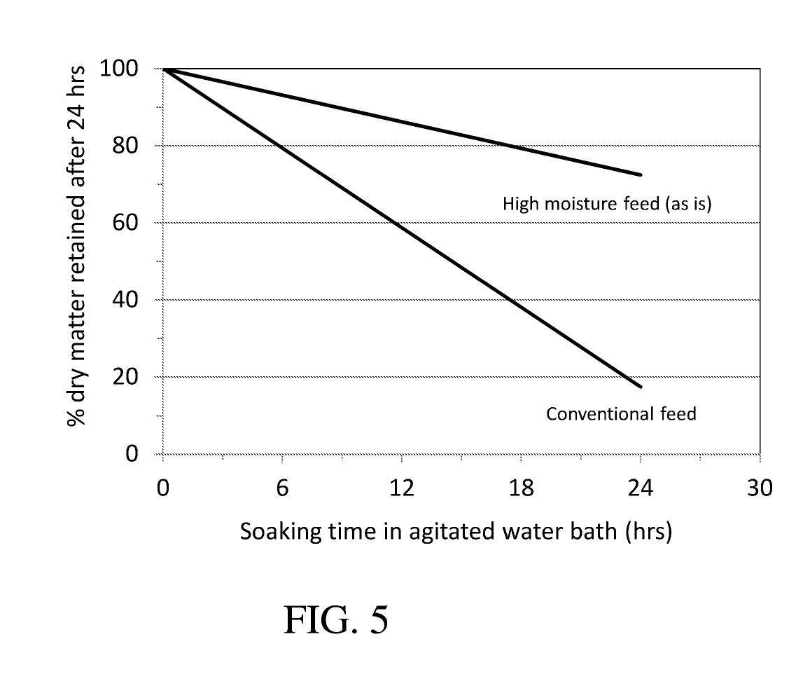

For the purpose of this disclosure, a “water-stable aquafeed” comprises an aquafeed with a “percentage of dry weight retained” value of greater than 25%, as measured using the water stability test. The water stability test is defined below. Data generated based on the water stability test is shown in Table 2 and graphically illustrated in FIG. 5.

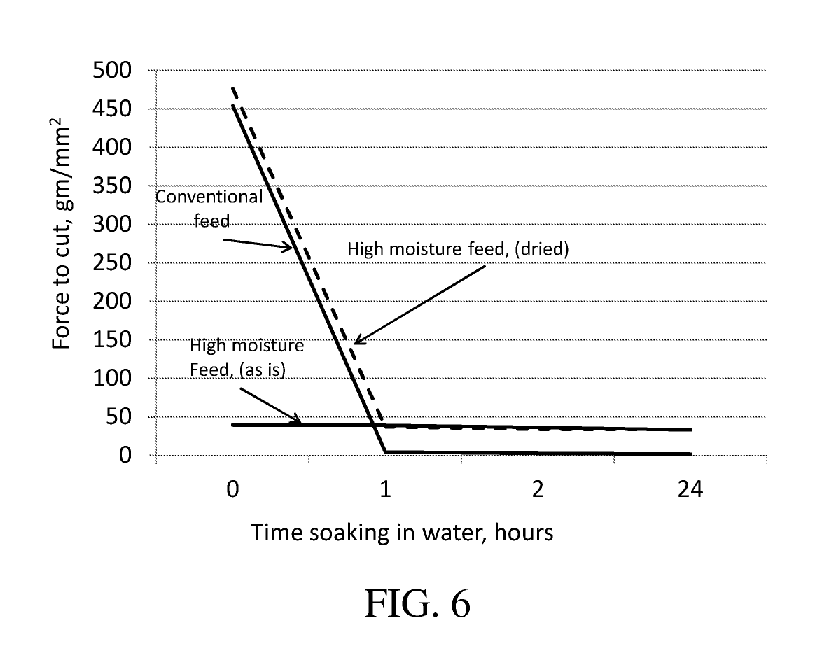

For the purpose of this disclosure, a “water-stable aquafeed” may alternatively be defined as comprising an aquafeed with a “maximum cut force” of greater than 10 g/mm² after being submersed in water for 1 hour, as measured using the post-submersion structural integrity test. The post-submersion structural integrity test is defined below. Data generated based on the post-submersion structural integrity test is shown in Table 3 and graphically illustrated in FIG. 6.

For the purpose of this disclosure, a “high-moisture aquafeed” comprises an aquafeed wherein, at the time the aquafeed leaves a tempering unit, the aquafeed product comprises at least 45% by weight liquid. The high-moisture aquafeed comprises only an ineffective amount of starch as a binder.

Note that the moisture content of the “high-moisture” aquafeed is determined at the time that the aquafeed emerges from the tempering unit. In a post-production process, the high-moisture aquafeed may be dried for shipment or storage. The dried “high-moisture” aquafeed can be rehydrated prior to use. After rehydration, the high-moisture aquafeed recovers the elasticity and water stability characteristics of the feed prior to drying.

For the purpose of this disclosure, “conventional feed” comprises an aquafeed that is produced by low moisture extrusion (without the use of a tempering unit, or the like), uses starch as a binder, has a hard porous texture, and has a moisture content of less than 10% moisture.

As shown in FIG. 1 and in accordance with the current method, a first step 10 comprises the preparation of a raw mixture comprising a combination of ingredients calculated to produce a complete and balanced diet for aquatic organisms. The ingredients may include (but are not limited to) wheat gluten, hill meal, squid meal, fish meal, soy protein products, oilseed protein products, corn gluten, corn gluten meal, pea or other legume protein products, grain products, mixed nut meal, poultry by-product meal, fish oil or any oil energy source, algae, vitamins and minerals. Oil may be added directly to the mix or injected into the extruder barrel or coated on top of the finished product. The raw mix that is used to make the high-moisture aquaculture feed is specifically formulated to produce a high-moisture product. There is no need to add starch to the raw mix to be used as a binder.

Table 1 shows the general composition of high-moisture feeds (described herein), and conventionally produced dry feeds, as well as the general composition fish flesh (Atlantic salmon) commonly found in the natural environment. Note that values in Table 1 are expressed as a percentage of dry matter (exclusive of moisture). Where multiple measurements were conducted, average values are shown.

Results show that conventional feed has a starch content of 13.70%. By contrast, high-moisture feeds contain less than 5% starch, because no starch is used as a binder. Interestingly, there is no difference in non-starch carbohydrate, which is basically cell wall material. Because of the starch difference, the total carbohydrate in high-moisture feed is significantly lower than the conventional feed. Also, compared to conventional feed, high-moisture feed is high in protein and low in oil, although oil can be added by a post-process procedure.

TABLE 1
Chemical composition of aquafeeds made by the invented
method as compared to control feeds

| | | | | | | | Non- |
|---|---|---|---|---|---|---|---|
| | | | | | Total | | starch |
| Feed sample | Moisture | Protein | Oil | Ash | CHO | Starch | CHO |
| Fresh salmon | 68.68 | 62.91 | 20.96 | 8.06 | 8.07 | | |
| Conventional | 5.85 | 50.08 | 15.60 | 7.41 | 26.92 | 13.70 | 13.07 |
| feed (dried) | | | | | | | |
| High-moisture | | | | | | | |
| feed (as is) | | | | | | | |
| Strand | 53.56 | 66.71 | 9.82 | 6.24 | 17.24 | 4.46 | 12.78 |
| Pellets | 56.33 | 66.41 | 10.00 | 6.09 | 17.50 | 4.58 | 12.91 |
| Bar | 55.73 | 71.25 | 5.75 | 5.29 | 17.72 | 3.84 | 13.89 |

After the dry mix is prepared, the mix is placed in a commercial extruder, as described in the second step 12 shown in FIG. 1. In the preferred embodiment, the extruder comprises a twin screw extruder (which is well known in the art) having multiple sections. The extruder is generally heated by a steam and/or (hot) water circulating system, directly with electricity or other methods of heating so that the extruder maintains a maximum operating temperature of between 80-200° C. Extruder screw speeds are generally maintained between 105 and 500 rpm, depending on the characteristics of the desired product.

As the extruder processes the mix, pressurized water is injected into the extruder mixing section, or immediately prior to the mixing section. A water injection pump is calibrated and designed to inject an amount of water into the mix so that the hydrated mixture comprises about 40-80% moisture. Alternatively, a pre-calculated amount of water can be incorporated into the raw mix before extrusion and, in this case, no injection pump is needed.

In the preferred embodiment, the hydrated mixture comprises about 50-70% (preferably 60%) moisture. Note that conventionally-produced fish feed generally comprises about 15-35% moisture during processing and less than 10% moisture after drying. Most actual fish flesh comprises about 75% moisture. The relatively high moisture content of the final product (produced in accordance with the current method) is due to the injection of a metered amount of water into the barrel of the extruder, or the addition of a calculated amount of water to the mix prior to extrusion.

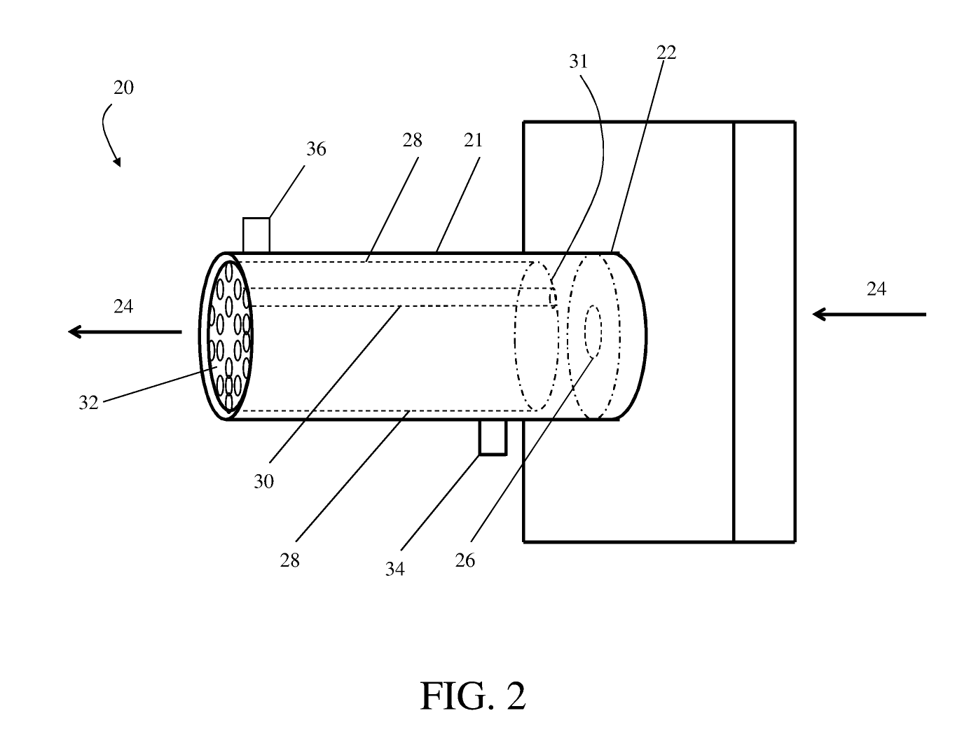

As shown in FIG. 1, in the third step 14 of the current process, extrudate leaves the extruder and is injected into a tempering unit 20 attached directly to an outlet of the extruder. FIG. 2 shows an outer housing 21 of the tempering unit 20 as it would be attached to an outlet portion of an extruder, with the extrudate moving through a distribution plate 22 (and a distribution plate aperture 26, and eventually leaving the tempering unit 20) in the direction of the arrow 24. As shown in FIG. 2, the distribution plate 26 and a tubular insert 28 are positioned within the outer housing 21 of the tempering unit 20. The distribution plate aperture 26 may have a variety of forms depending on the viscosity and characteristics of the extrudate entering the tempering unit 20.

After the extrudate passes through the distribution plate aperture 26, the extrudate is forced into the tubular insert 28. In the preferred embodiment, the tubular insert 28 comprises a matrix of multiple elongated tubes 30. The tubes 30 are connected by (at least) proximal 31 and distal 32 end plates. For the sake of simplicity, only one exemplary tube 30 is shown in FIG. 2, however, the tubular insert 28 preferably comprises multiple tubes 30. The tubes 30 are spaced so that a tempering fluid can be circulated through the tempering unit 20 and around the tubes 30, thereby effectively cooling and controlling the temperature of the extrudate as it moves through each of the tubes 30. The tempering fluid is injected into an inlet port 34, circulated through the tempering unit 20, and then circulated out of the tempering unit 20 through an outlet port 36.

By controlling the temperature and flow rate of the tempering fluid within the temping unit 20, an operator can precisely control the temperature of the extrudate within the tempering unit 20. The optimal temperature of the extrudate within the tempering unit varies depending upon the feed formulation, feed rate of the mix, hydroscopic properties of the mix, and the desired characteristics of the final product.

Similarly, the pressure of the extrudate within the tempering unit 20 is controlled primarily by the flow capacity of the extruder relative to the size and nature of the elongated tubes 30 within the tempering unit 20. Constricting the movement of extrudate out of the tempering unit 20 (via nozzles or the like) increases the pressure on the extrudate within the tempering unit 20. Similarly, for fixed dimensions within the tempering unit 20, increasing the output rate of the extruder (via an increase in screw speeds or the like) also increases pressure within the tempering unit 20.

By controlling the extrudate pressure (via the extrudate flow rate or by other means) within the tempering unit, an operator at least partially controls the moisture level of the extrudate (and ultimately the aquafeed product) by preventing the uncontrollable loss of moisture through the flashing process. Controlling the pressure within the tubular insert has the effect of controlling the expansion rate of the extrudate within the tubular insert. In the preferred embodiment, the temperature of the extrudate within the tempering unit 20 varies between 5 and 150° C. After passing through the distal end plate 32, the final aquafeed product streams out of the tempering unit 20 in the direction of the arrow 24.

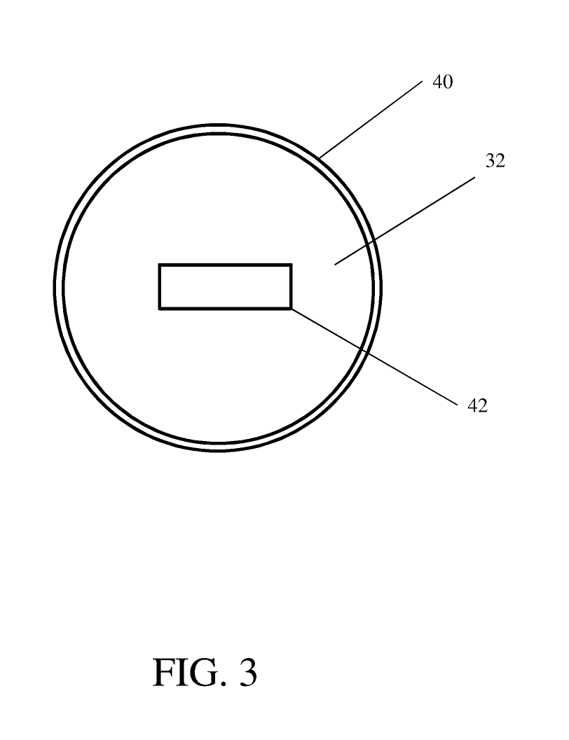

In alternative embodiments, the “tubes” 30 may have a variety of shapes, consistent with the shape of the desired final product. For example, the circular tubes 30 shown in FIG. 2 produce a product with a “strand” type format. FIG. 3 shows an alternative embodiment comprising a rectangular “bar” type tubular insert 40. As shown in FIG. 3, in a bar-type tubular insert 40, the proximal 31 (not shown) and distal 32 end plates have elongated rectangular apertures 42. In one alternative embodiment, the extrudate emerging from the rectangular aperture 42 is cut into thin (e.g. 1 cm thick) bars and subsequently formed into the shape of a bait fish (for example, a sardine shape).

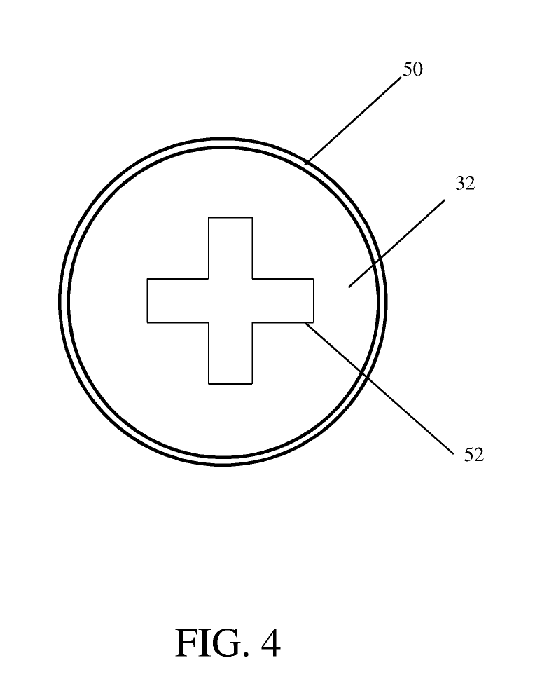

Similarly, FIG. 4 shows a distal end plate with a “cross” type tubular insert 50. The cross-shaped tubular insert produces an aquafeed with a cross-type format. The cross-shaped aquafeed product has the advantage of tumbling or twirling as it falls through the water, thereby providing more movement to the feed in hopes of eliciting a feeding response. Other aquafeed shapes (with corresponding tubular insert apertures) should be considered within the scope of the invention.

Although the method and apparatus are described herein with reference to a preferred embodiments, multiple alternative embodiments may also exist. For example, although the tubes 30 shown in FIGS. 2, 3, and 4 have round, rectangular, and cross-shaped forms, the tubes 30 may have a square-, triangle-, hexagonal-, or other alternative-shaped forms. The number and arrangement of the tubes 30 may also be varied. For example, the tubes 30 may be arranged around the outer periphery of the tubular insert 28 so that the tubular insert 28 has a solid core/center with the tubes 30 arranged around the center core. Further, the tempering unit 20 may have more than one tempering fluid inlet 34 and outlet 36, as required to precisely control the temperature of the extrudate within the unit 20.

During the production of conventional (low-moisture) aquafeed, the raw mix is extruded directly from the extruder barrel (without the benefit of the controlled cooling and expansion provided by the tempering unit described herein). As a part of the conventional mixing process, the mix is pressurized within the extruder barrel so that there is a sudden pressure drop as the mix emerges from the extruder. The pressure drops causes the extrudate to expand rapidly—which results in an increase in the porosity and the volume of the extrudate product. Carbohydrate is required in the raw mix to effectively bind the produced extrudate into a discrete form. The carbohydrate binder used in prior art processes effectively forms the extrudate into a matrix that allows for the absorption of oil and traps air bubbles so that pellets produced from the conventionally-formed extrudate float.

By contrast, in accordance with the method described herein, the current process begins in the extruder with much higher moisture levels than used for conventional feeds. As the extrudate leaves the extruder and enters the tempering unit 20, the temperature and pressure drop is controlled and gradual (unlike prior art processes) so that there is no uncontrolled expansion of the extrudate and moisture is not uncontrollably lost through the flashing process. The controlled cooling of the extrudate prevents the formation of relatively large air pockets within the extrudate and results in a retention of moisture, a smooth surface (i.e. a lack of porosity) and a stable texture of the extrudate.

Because the extrudate expansion is controlled through cooling and a relatively slow pressure release (unlike the conventional process), the addition of a supplemental binding agent (such as starch) is not required. The resulting aquaculture feed product has a texture that is smooth (not porous), fibrous, and has a generally elastic (almost “gummy”) feel that more closely resembles the texture of natural aquatic foods (such as bait fish). Additionally, upon submersion in water, aquatic feed produced by the current process retains its structural cohesion for an extended amount of time.

### Post—Production Processing

As shown in FIG. 1, in an optional fourth step 18 of the current process, the high-moisture aquafeed product may undergo a variety of post-production processes. For example, the high-moisture aquafeed can be shredded or ground using a variety of processing equipment including, but not limited to, a mincer, roller grinder or pin mill to sizes of 10 microns to 1000 microns. These small, high-moisture particles can be used for the first feed for larval aquatic animals. The high-moisture content will slow the osmotic rush of water into the particle helping to retain essential water-soluble nutrients. These nutrients may include but are not limited to B vitamins and crystalline amino acids including, but not limited to, arginine lysine, glycine, alanine, and taurine.

The final aquafeed product may also be dried, refrigerated, or frozen for later use. The high-moisture particles can be dried to less than 10% moisture. The particles may then be ground and sifted to appropriate sizes, and then stored and shipped. The particles can then be rehydrated on-site in a vitamin/amino acid solution to further enhance the content of water soluble nutrients and thereby restore the particle's soft texture and elastic structural integrity.

The aquafeed product can also be “formed” (preferably) immediately after it emerges from the tempering unit. A forming unit or multi-knife cutter-head may be attached onto the end plate 32 of the tempering unit 20 to form the aquatic feed product into a variety of forms.

### Water Stability Tests and Data

One means (described in greater detail below) used by the industry to determine “water-stability” comprises a “water stability test”. For the purposes of this disclosure, the “water stability test” comprises a process wherein a subsample of the aquafeed product is dried and weighed before and after the product is submersed in an agitated water bath for 24 hours at room temperature. A final dry weight of the product (after soaking in the agitated bath) is compared to the initial dry weight ((final dry weight—divided by—initial dry weight)*100) to determine a “percentage of weight retained”. As shown in Table 2 below, the “percentage of weight retained” value for conventional aquafeeds is about 17%, while the percentage of weight retained for the high-moisture feeds is greater than 70%.

For the purpose of this disclosure, a “water-stable aquafeed” comprises an aquafeed with a “percentage of weight retained” value of greater than 25%, as measured using the water stability test described herein.

With regard to the specifics of the water stability test used to generate the data presented in Table 2, three types of feed were tested: (1) a “bar” type high-moisture feed (26 mm wide, 13 mm thick and 70 mm long); (2) a “strand” type high-moisture feed (3.5 mm in diameter); (3) and a conventionally-produced dry pellet (also 3.5 mm in diameter). One hundred grams of each material was placed in a 500 ml beaker and filled with water to 500 ml. The beakers were placed in a shaking water bath held at 20° C. and shaken at 85 rpm for 24 hours. The samples were removed, drained of water, and sifted through a 2.7 mm screen with light rinsing and then dried at 60° C. for 24 hours, followed by 80° C. for an additional 24 hours. The material was then weighed and the percentage of dry weight retained calculated. The results are shown in Table 2 below:

TABLE 2
The effect of water submersion on
sample weight loss over 24 hours.

| | Starting weight | | After 24 hr submersion and shaking | |
|---|---|---|---|---|
| Feed ^{a} | As-is, g | Dry, g | Dry, g | Weight retained, % |
| Bar type | 100.7 | 54.3 ^{x} | 39.3 | 72 ^{x} |
| Strand type | 100.0 | 56.8 ^{x} | 40.1 | 70 ^{x} |
| Conventional | 100.4 | 94.5 ^{y} | 16.5 | 17 ^{y} |

^{a} Each feed type was tested with triplicate samples
^{x} numbers with different superscripts are different (P < 0.01)

The data shown in Table 2 is (generally) graphically expressed in FIG. 5. As illustrated in FIG. 5, feed pellets produced by conventional extrusion retained significantly less weight (17.4%) compared to the high-moisture feed. The high-moisture feed retained approximately 71% of its dry weight. The conventional feed disintegrated significantly upon soaking in the shaking water bath. In contrast, high-moisture feed did not. Some of the loss from the high-moisture feed was from oil and some water soluble nutrients, but the high moisture feed remained intact and elastic.

As an alternative or supplement to the water stability test described above, “a post-submersion structural integrity test” (or “alternative water stability test”) also provides a measure of the water stability of the aquafeed product. For the purposes of this disclosure, the “post-submersion structural integrity test” comprises a process wherein an aquafeed is submersed in a (non-agitated i.e. static) room temperature water bath for a specified time (e.g. one hour) and then cut by a 1 mm blade (thickness) to determine a “maximum cut force” value expressed in g/mm² using a force measuring instrument.

For the purpose of this disclosure, a “water-stable” aquafeed comprises an aquafeed with a “maximum cut force” of greater than 10 g/mm² after being submersed in water for 1 hour, as measured using the post-submersion structural integrity test described herein.

With regard to the specifics of the post-submersion structural integrity test used to generate the data presented in Table 3, sinking salmon feed (conventional feed) and three forms of high-moisture aquafeed, as well as fresh salmon were tested. A TA.XT Plus analyzer, with a 50 kg load cell and TA90 platform was used to test the aquafeed products. A triangle-slotted cutting blade (1 mm thickness), also known as Warner Bratzler, was mounted to the machine.

Each sample (after soaking in water for a selected duration (see Table 3)) was put on the platform with a 2 mm (width) slot. The blade advanced downward, at a speed of 2 mm/second, to cut through the sample. Regardless of the crosscut shapes of samples, only half of the perimeter surface was in contact with the blade edge. This value times 1 mm (blade thickness) was used to calculate the area that contacted the blade. For comparing structural integrity among samples, the maximum force measured was divided by the calculated area, and expressed as g/mm² of the contact surface by the blade.

TABLE 3
Structural integrity (maximum force, g/mm², to
cut through) after soaking in water of high-moisture
feeds and conventional extruded feed.

| | Initial | | | | | | |
|---|---|---|---|---|---|---|---|
| | moisture | Water soaking time (hours) | | | | | |
| Feed samples | % | 0.00 | 0.16 | 1.00 | 2.00 | 4.00 | 24.00 |
| Fresh salmon | 64.8 | 29 | | | | | |
| Conventional | 5.8 | 436 | 96 | 6 | 4 | 4 | 3 |
| extruded feed | | | | | | | |
| High-moisture feed | | | | | | | |
| Strand (dried) | 8.3 | 476 | 188 | 36 | 35 | 38 | 34 |
| Strand (as is) | 53.6 | 43 | 31 | 27 | 24 | 25 | 27 |
| Pellets (as is) | 56.3 | 41 | 23 | 22 | 20 | 20 | 22 |
| Bar (as is) | 59.1 | 39 | 38 | 39 | 36 | 36 | 33 |

The data shown in Table 3 is (generally) graphically expressed in FIG. 6. Fresh salmon has a maximum cut force of 29 g/mm². FIG. 6 illustrates that conventional aquaculture feed is initially hard and rigid, having a maximum force of 436 g/mm2. However, the structural integrity of the conventional feed declines rapidly in the first hour upon submersion in water. The feed has essentially negligible structural integrity/cohesion after the first hour of water submersion.

By contrast, the structural integrity of the high-moisture aquafeed remained relatively unchanged over the first 24 hours. Although some softening was observed in the first ten minutes, most of the high-moisture aquafeeds remained within 21 to 35 g/mm2 range (designated by the inventors as the “Goldilocks range”) for the duration of the test.

Addtionally, as mentioned above, in a post-production process, the high-moisture aquafeed can be dried for storage and shipping. The characteristics of high-moisture aquafeed that has been dried is shown in Table 3 (and FIG. 6) as “Strand (dried)”.

The dried high-moisture feed initially has a structural integrity similar to conventional feed. However, as the dried high-moisture feed is rehydrated, the feed begins to exhibit characteristics similar to high-moisture that was not subjected to the drying process. After 24 hours, the dried high-moisture feed exhibits essentially the same structural integrity as the “non-dried” high-moisture feed.

The ability to dry and then subsequently rehydrate the feed has important implications for storage, handling, and transportation of the feeds. Pellet Durability Index (PDI) values are determined (using a Holmen Pellet Tester NHP 100). Based on initial testing and observations, the high moisture feed described herein has a PDI value that is comparable to conventional dried feeds.

### EXAMPLE

During “proof of concept” evaluations, extrusions were performed using a pilot-scale, co-rotating, intermeshing, twin-screw extruder (DNDL-44, Buhler AG, Uzwil, Switzerland) with a smooth barrel and a length/diameter ratio of 32:1 (1422 mm long and 44 mm screws). The barrel of the extruder consists of 6 temperature-controlled sections. Sections 2, 3, 4, and 5 are heated by steam and section 6 is digitally controlled by heated recirculating water (model HY 4003HP, Mokon, Buffalo, N.Y.). The screws are built to have a feed section, mix section, a work section with reversed screw elements, and a final conveying section.

The extruder further comprised a twin screw gravimetric feeder (KT-20, K-tron Corp, Pitman, N.J.) that was used to feed the raw materials into the extruder at a feeding rate of 10 kg/h. While operating, water at ambient temperature was injected, via an inlet port, into the extruder by a positive displacement pump with ˜4.5 bar pressure. The inlet port was located on the bottom of the barrel, 0.108 m downstream from the feeding port. The pump was pre-calibrated and adjusted so that the extrudate moisture content would vary from 40 to 80%.

Optimal screw speeds were varied, dependent on formulation, between 105 and 550 rpm. At the end of the extruder, the tempering unit was attached, with a dimension of 300 mm long and 102 mm in diameter. Each of the insert assembly, regardless of size or shape of the channels, contained 19 mm² of open area. The tempering unit was connected to a digitally thermostatically controlled device (model MT 2002 00, Mokon, Buffalo, N.Y.) that maintained the temperature of the tempering unit to ±2 C, and optimal temperature varied from 5 to115° C. depending on feed rate formulation, moisture level, and desired product. The finished product was examined for defects and determined to be sufficient for its intended use.

For the foregoing reasons, it is clear that the method and apparatus described herein provides an innovative method and apparatus for (among other things) manufacturing a water-stable aquatic feed. The current system may be modified in multiple ways and applied in various technological applications. The disclosed method and apparatus may be modified and customized as required by a specific operation or application, and the individual components may be modified and defined, as required, to achieve the desired result.

Although the materials of construction are not described, they may include a variety of compositions consistent with the function described herein. Such variations are not to be regarded as a departure from the spirit and scope of this disclosure, and all such modifications as would be obvious to one skilled in the art are intended to be included within the scope of the following claims.

1-22. (canceled)

23. A method of producing water-stable aquafeed, the method comprising the steps of:
(a) preparing a raw mix;
(b) depositing the raw mix into an extruder;
(c) providing a tempering unit that is attached to the extruder;
(d) positioning a tubular insert within the tempering unit, the tubular insert receiving an extrudate from the extruder and controlling an expansion of the extrudate;
(e) circulating a tempering fluid around the tubular insert and thereby controlling cooling a temperature of the extrudate as it moves through the tubular insert; and,
(f) producing the water-stable aquafeed from the tubular insert within the tempering unit.

24. The method of claim 23 wherein, in step (a), the raw mix comprises 40-80% liquid so that the water-stable aquafeed produced in step (f) is a high-moisture water-stable aquafeed.

25. The method of claim 23 wherein, after step (f), the high-moisture water-stable is ground or shredded to sizes of 10 microns to 1000 microns suitable for larval aquatic animals.

26. The method of claim 23 wherein, after step (f), the high-moisture water-stable aquafeed is dried to less than 10% moisture.

27. The method of claim 26 wherein after the high-moisture water-stable aquafeed is dried to less than 10%, it is rehydrated so that the rehydrated product has essentially a same cut force/structural integrity value (as measured by a water stability test) as exhibited by high-moisture aquafeed that has not been previously dried.

28. The method of claim 27 wherein the dried high-moisture aquafeed is rehydrated in a vitamin/amino acid solution.

29. A method of producing a high-moisture water-stable aquafeed comprising attaching a tempering unit to an extruder, the tempering unit controlling the temperature, pressure, and expansion rate of extrudate so that high-moisture water-stable aquafeed is produced from the tempering unit.

30. The method of claim 29 wherein the high-moisture water-stable aquafeed is produced without a starch binder.

31. The method of claim 29 wherein the tempering unit comprises a tubular insert, the tubular insert comprising at least one tube.

32. The method of claim 31 wherein the tempering unit comprises a circulating system circulating a tempering fluid around the at least one tube.

33. The method of claim 29 wherein after the high-moisture water-stable aquafeed is produced, the aquafeed is subject to one of drying, grinding, shredding, freezing, or forming.

34. A water-stable aquafeed product produced by the method of claim 23.

35. A high-moisture water-stable aquafeed product produced by the method of claim 24.

36. A high-moisture water-stable aquafeed produced by the method of claim 29.

37. A high-moisture water-stable aquafeed produced by the method of claim 30.

38. A high moisture water-stable aquafeed produced by the process of hydrating a dry mix in the extruder and producing an extrudate out of the extruder and into a tempering unit so that the temperature of the extrudate is decreased in the tempering unit, and producing the high moisture water-stable aquafeed out of the tempering unit.

39. The aquafeed product of claim 38 wherein the high moisture water-stable aquafeed contains no or an ineffective amount of starch as a binder.

40. The aquafeed product of claim 38 wherein the aquafeed product may include one or more of the following:
wheat gluten, hill meal, squid meal, fish meal, soy protein products, oilseed protein products, corn gluten, corn gluten meal, pea or other legume protein products, grain products, mixed nut meal, poultry by-product meal, fish oil or any oil energy source, algae, vitamins and minerals.
